(19) United States
(12) Patent Application Publication
(10) Pub. No.: US 2024/0144184 A1
(43) Pub. Date: May 2, 2024

(54) VIRTUAL REALITY (VR)-BASED SIMULATED BUSINESS INTELLIGENCE REPORT VISUALIZATION

(71) Applicant: International Business Machines Corporation, Armonk, NY (US)

(72) Inventors: Sarbajit K. Rakshit, Kolkata (IN); Subha Basu, Howrah (IN); Sourav Banerjee, Konnagar (IN); Surbhi Walia, Pune (IN)

(21) Appl. No.: 17/976,646

(22) Filed: Oct. 28, 2022

(51) Int. Cl. G06Q 10/10; G06F 3/01; G06T 19/00

(52) U.S. Cl. CPC G06Q 10/103; G06F 3/011; G06T 19/006

(57) ABSTRACT

A computer-implemented method, in accordance with one embodiment, includes analyzing a business intelligence report for correlating information therein with a physical environment, and for determining effects of the information in the business intelligence report on the physical environment. An animated virtual reality simulation of the physical environment, as affected by the information, is created based on results of the analysis of the business intelligence report. The animated virtual reality simulation is output to a virtual reality device.

### BACKGROUND

The present invention relates to Virtual Reality (VR)-based simulation, and more specifically, this invention relates to VR-based simulated business intelligence report visualization.

VR is a computer-generated environment with scenes and objects that appear to be real, making the user feel as if they are immersed in their surroundings. This environment is perceived through a head-mounted VR device known as a VR headset or VR helmet. VR allows users to immerse themselves in video games as if they were one of the characters, learn how to perform heart surgery, or improve the quality of sports training to maximize performance.

VR collaboration platforms allow users to collaborate in virtual reality from remote locations. These solutions enable users to meet up in the same virtual space and communicate through both speech and text. VR collaboration platforms offer users the ability to choose and edit avatars to represent their likeness as well as custom environments to host a virtual meetup. Within virtual meetups, users can host virtual presentations, edit and visualize designs, and collaborate and socialize on team projects.

Data visualization is a method of representing the data in a presentation format, like plotting data in graph, chart, map, etc., so that user can quickly visualize the data. However, data visualizations presently are two dimensional, providing only a visual representation of the numbers in the data, e.g., a bar in a chart, a line on a graph, etc.

### SUMMARY

A computer-implemented method, in accordance with one embodiment, includes analyzing a business intelligence report for correlating information therein with a physical environment, and for determining effects of the information in the business intelligence report on the physical environment. An animated virtual reality simulation of the physical environment, as affected by the information, is created based on results of the analysis of the business intelligence report. The animated virtual reality simulation is output to a virtual reality device.

A computer program product, in accordance with one embodiment, includes a computer readable storage medium having program instructions embodied therewith. The program instructions are executable by a computer to cause the computer to perform the foregoing method.

A system, in accordance with one embodiment, includes a processor and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 depicts a conventional BI predictive data visualization, in arbitrary units and data.

FIG. 3 is a flowchart of a method, in accordance with one embodiment.

FIG. 4 is a flowchart of a method, in accordance with one embodiment.

FIG. 5 is an illustration of a user wearing a VR device to view a virtual reality simulation of the inside of a retail store, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for systems, methods and computer program products for VR-based simulated Business Intelligence (BI) report visualization. In one aspect, the outcome of a BI report is considered according to a given sets of parameters to perform contextual analysis of the BI report (such as the displayed items in the report, associated values, types of reports, etc.) to simulate an impacted physical location and to recreate appropriate virtual visualizations of the impacted physical location in the VR environment. Thus, the scenario of the workplace can be represented based on the BI report, e.g., to present to a user how the actual scenario was at the workplace at the time of BI report content, as well as what can happen in the future.

In one general embodiment, a computer-implemented method includes analyzing a business intelligence report for correlating information therein with a physical environment, and for determining effects of the information in the business intelligence report on the physical environment. An animated virtual reality simulation of the physical environment, as affected by the information, is created based on results of the analysis of the business intelligence report. The animated virtual reality simulation is output to a virtual reality device.

In another general embodiment, a computer program product includes a computer readable storage medium having program instructions embodied therewith. The program instructions are executable by a computer to cause the computer to perform the foregoing method.

In another general embodiment, a system includes a processor and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as BI report visualization code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

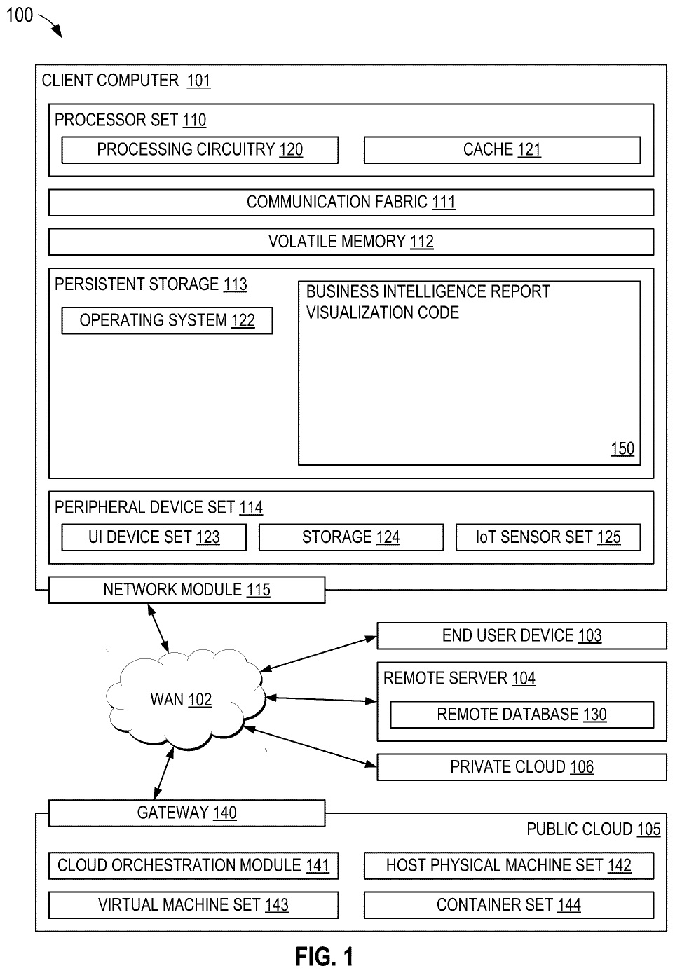

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

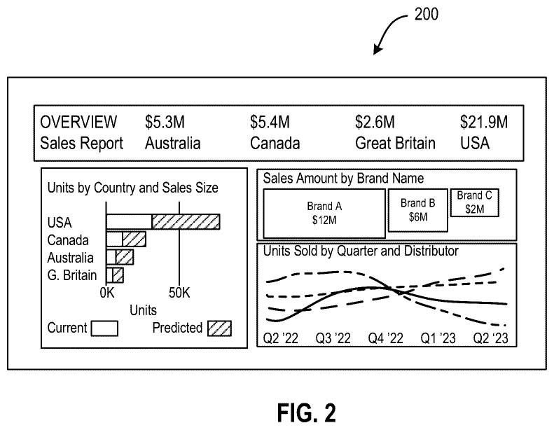

FIG. 2 depicts a conventional BI predictive data visualization 200, in arbitrary units and data. The visualization 200 basically allows a user to visualize BI data, such as sales-related information, in a presentable 2D format. As shown, the data is typically plotted in a graph, map, chart, etc., often with labels and numbers. However, the user is never presented with a visualization of what can happen physically. Rather, it is up to the user to imagine what will physically happen in the real world based on the predicted information from the BI report.

Accordingly, various embodiments presented herein enable use of actual (e.g., historic) and/or predicted data from a BI report to simulate physical surroundings corresponding to the BI report, and presents simulated physical surroundings in a VR environment.

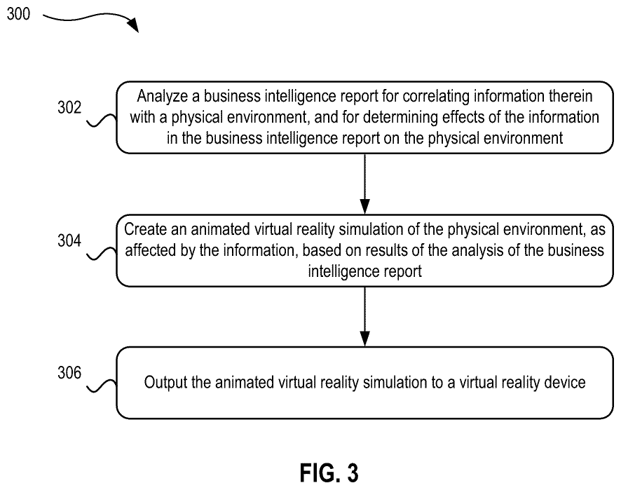

Now referring to FIG. 3, a flowchart of a method 300 is shown according to one embodiment. The method 300 may be performed in accordance with the present invention in any of the environments depicted in FIGS. 1-2, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a BI system, a VR system, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where a BI report is analyzed for correlating information therein with a physical environment, and for determining effects of the information in the BI report on the physical environment.

In operation 304, an animated virtual reality simulation of the physical environment, as it is affected by the information, is created based on results of the analysis of the BI report.

In operation 306, the animated virtual reality simulation is output to a virtual reality device of any known type, preferably a head-mounted VR device such as a headset or helmet; a VR chamber; etc. The VR device may be the end user device 103 of FIG. 1.

The BI report may be of any type known in the art. The BI report may be received, may be generated, may be purchased, etc. The BI report may be generated according to any known method for creating such reports. The BI report may be in any format, such as a data file, information in a database, etc. In some aspects, each and every BI report is useful for specific purpose, and has associated metadata information, such as the purpose of the report, what type of business scenario is addressed in the report, etc.

The BI report may include any conventional BI information that would become apparent to one skilled in the art upon reading the present disclosure. Examples of BI information include sales data, manufacturing output, machine maintenance, average number of customers over time, etc.

Results from a relational or multi-dimensional database may be captured based on different types of queries from the BI reporting application, such as SQL, MDX, DMX, DAX, etc. and the results are used for constructing the virtual reality environment shown in the simulation.

A set of parameters may be received for defining the information in the BI report. In one approach, a BI report processing system generates different types of reports based on parameters selected by a user. Illustrative types of reports include reports presenting predicted results, historical trends, measured values, analytics, etc. For present purposes, the BI report analyzed in operation 302 may comprise multiple BI reports, e.g., the BI report analyzed is a collection of other BI reports in some cases.

The physical environment may be any desired physical environment. In one approach, selection of the physical environment is received from a user. In another approach, a physical environment is selected based on the information in the BI report. In yet another approach, the physical environment is a default physical environment.

In some approaches, the physical environment is an actual physical location that is associated with the information in the BI report in some way. For example, a particular “brick and mortar” retail store may be associated with a BI report of foot traffic through a front door of the retail store.

In other approaches, the physical environment is not a location that is associated with the information. Rather, the physical environment may be one that is based on a real life location, and the method 300 is used to simulate the effects of the information in the BI report at such location.

In other approaches, the physical environment does not exist in reality, but is created for purposes of simulating the effects of the information in the BI report on the created physical environment. In such case, the physical environment may be selected by a user, may be created based on a set of parameters, may be fabricated based on the information in the BI report, etc. An example of such an embodiment may be where a location to build a restaurant is being sought, and information from the BI report is being used to simulate foot and vehicular traffic around a restaurant generated in VR. In a variation, a model of an actual restaurant at one location may be used to simulate a restaurant at a location that is currently undeveloped.

Based on the types of BI reports (such as trends, predictions, etc.), types of data and information (such as machine maintenance, sales data, etc.), and context of the BI report, the proposed system may perform various types of simulations. In one approach, the output of the BI report is analyzed and changes in the data elements are identified. A mapping of the data elements with the virtual objects, like product name, etc. is performed.

The animated virtual reality simulation may be created using known techniques, modified of course according to the teachings herein, as would become apparent to one skilled in the art upon reading the present disclosure. Preferably, the outcome of the BI report is determined and sent to a VR content generation system. Any type of VR content generation system known in the art may be used, such as one having image generation, avatar generation, virtual object generation, etc.

In one approach, the virtual reality simulation includes an animated visual simulation of the physical environment upon which the information is based. In another approach, the virtual reality simulation includes a digital twin of the physical environment upon which the information is based. Objects of the digital twin may be animated, and/or other objects may be animated within the digital twin.

In another embodiment, the virtual reality simulation includes an augmented reality (AR) based visualization of the BI report overlaid over a physical environment, e.g., an image or video of a physical environment, an overlay projected onto an AR lens worn by a user such that AR animations appear over real world objects being viewed by the user, etc. Accordingly, a virtual reality simulation need not simulate all aspects of a physical environment, but rather in some approaches may simulate parts of the environment and/or provide overlays that depict some aspect of the environment as it was, is, and/or will be affected according to information in the BI report.

In yet another embodiment, the virtual reality simulation includes a combination of visual and digital twin simulations of the physical environment upon which the information is based. Thus, a visual and/or digital twin simulation may be generated to create a visualization in the VR simulation of the physical environment to represent the BI report context.

Preferably, the method 300 considers the outcome of a BI report with any given set of parameters to perform contextual analysis of the BI report (such as the displayed items, associated values, types of reports, etc.) to simulate the impacted physical environment (e.g., workplace) and is thereby able to recreate an appropriate virtual visualization in a VR simulation which represents the scenario of the physical environment based on the BI report. This allows creation of a representation for a user depicting what the actual scenario at the location was at the time of the BI report content, and/or what can happen in a future timeline.

Accordingly, in one embodiment, the virtual reality simulation includes a simulation of the physical environment at a time corresponding to when at least some the information of the BI report was collected, preferably with animations generated based on information in the BI report. For example, if the BI report indicates that foot traffic changes over time, then animated people corresponding to the number of people in the BI report may be added to the virtual reality simulation.

In another embodiment, the virtual reality simulation includes a predictive simulation of the physical environment at a time in the future relative to when the information of the BI report was collected. Preferably, predictive information in the BI report is identified and analyzed for generating the predictive simulation. Such predictive information may include projections, trends, estimated values, and the like that are determined by the BI system using conventional predictive techniques and added to the report. In some approaches, some of the predictive information may be based on user input, e.g., a user inputs an expected value into the BI system, and the value is then translated into information for the BI report.

In yet another embodiment, the virtual reality simulation includes a simulation of the physical environment based on both information based on actual collected data as well as predictive information.

Preferably, the virtual reality simulation allows a user to change the parameters used to create the BI report, and thus the virtual reality simulation. As described in more detail below, parameters may be related to time, what information is depicted in the virtual reality simulation, etc. Based on the change in parameters, changes in the report outcome are determined, and accordingly the system uses an appropriate simulation method (e.g., visual simulation, digital twin simulation, etc.) to create a virtual reality simulation of the BI report, so that a user can realize the changes in the physical environment depicted in the virtual reality simulation.

For example, a set of parameters for defining a context of the analysis may be received. The analysis is performed based on the set of parameters. Thus, the resulting virtual reality simulation reflects the set of parameters. Illustrative parameters include selection of a time factor; factors derived from user-navigation of a BI report, such as drill down, drill up, cross drilling, drill through, etc.; etc.

Preferably, while a user is interacting with the virtual reality environment, the user's actions and interactions in the simulated physical location correlated to the BI report are detected. An identification is made as to which parameters to change and/or what action to perform, and accordingly an appropriate simulated visualization of the BI report is generated.

The parameters may be derived from user input, e.g., in real time, according to a schedule, etc. In various approaches, the parameters are received based on gesture, body language, brain computer interface (BCI) signals, voice commands, virtual touch, etc. and preferably the requisite parameters for the BI report are derived therefrom and used to dynamically create the visualization of the BI report.

Artificial intelligence may be used to perform contextual analysis of interactions with the BI report to derive parameters to be applied in the BI report and/or to identify what action a user wants to perform apart from parameter selection, such as drill up, drill down, etc. The identified action is analyzed based on VR content analysis, and accordingly the appropriate BI function is executed in response thereto.

In one embodiment, the parameters are related to a timeline. For example, input is received for changing a time factor for the virtual reality simulation such as a particular day, a particular day and time, a time range, etc. The virtual reality simulation is updated to correspond to the changed time factor. The time factor can be in the past, present or future. Thus, for example, a business user can move the simulation in the time dimension, such as along a past or future timeline, and accordingly the BI report execution engine receives the time range parameter and creates appropriate visualization of the BI report with VR visualization.

In another embodiment, input is received indicating a selection of a different BI report such as a new report altogether, a different portion of the present report, etc. The different BI report is analyzed for correlating information therein with the same physical environment, and for determining effects of the information in the BI report on the physical environment. A second virtual reality simulation of the physical environment, as affected by the information of the different business report, is created and output. Note that the second virtual reality simulation may be an entirely different simulation, a modified version of the presently-playing simulation (e.g., to provide a continuous experience), etc.

In one embodiment, the set of parameters is derived from a user's selection of particular information from the BI report to analyze. Such information may be information selected from within the simulation, e.g., to drill up, drill down, or drill across to other information.

In one approach, the set of parameters is based, at least in part, on output from one or more sensors detecting one or more human interactions selected from the group consisting of: a gesture, body language, brain computer interface (BCI) signals, a voice command, and a virtual touch. For example, a BCI system that can analyze a user's brain signals and execute on the content being visualized to derive the user's intent may be used.

The input based on user interactions, sensors, etc. may be received outside of the simulation, but preferably is received during the outputting of the virtual reality simulation, and the virtual reality simulation is updated based on the set of parameters. Accordingly, in some approaches, the system identifies a user's action on the BI report, and from such action, determines what types of changes are to be shown in the VR visualization. Illustrative actions include drill down, drill up, cross drilling, drill through (viewing the individual raw data), etc. Thus, for example, while navigating any BI report, a user can be allowed to select any BI report to be navigated for any interaction from a BI report catalogue. Based on the selection of the report, a default visualization based on the default parameter used in the report may be created.

In one embodiment, specification of the physical environment such as a particular location, an address, a type of physical environment such as a retail store or a warehouse, etc. is received. The analysis includes selection of information in the BI report relevant to the specified physical environment. Preferably, a user can select any BI report output and can select any relevant workplace, and accordingly the selected workplace is simulated in virtual reality as per the BI report output.

In some aspects of the present invention, using VR collaboration, multiple users can collaborate on the same BI report. Accordingly, in one embodiment, the virtual reality simulation is also output to a second virtual reality device for allowing collaboration of multiple users in the virtual reality simulation.

What is output during the collaboration may be based on the respective user's privilege, permission level, security level, etc. (collectively “permission level”) to visualize different sets of data, and thus, portions of the virtual reality simulation output to the second virtual reality device may be removed based on a permission level of the user associated with the second virtual reality device.

In another approach, the VR collaboration system creates multiple VR environments (e.g., a common (shared) simulated VR environment and private simulated VR environment) for the respective users, via which the users can collaborate with each other. For example, in one embodiment, a second analysis of the BI report is performed based on a permission level of a second user. A second virtual reality simulation of the physical environment, as affected by the information based on results of the second analysis, is created. The virtual reality simulation is output to a second virtual reality device for allowing collaboration of multiple users in the virtual reality simulations. Preferably, avatars of the users are generated and presented in both of the virtual reality simulations.

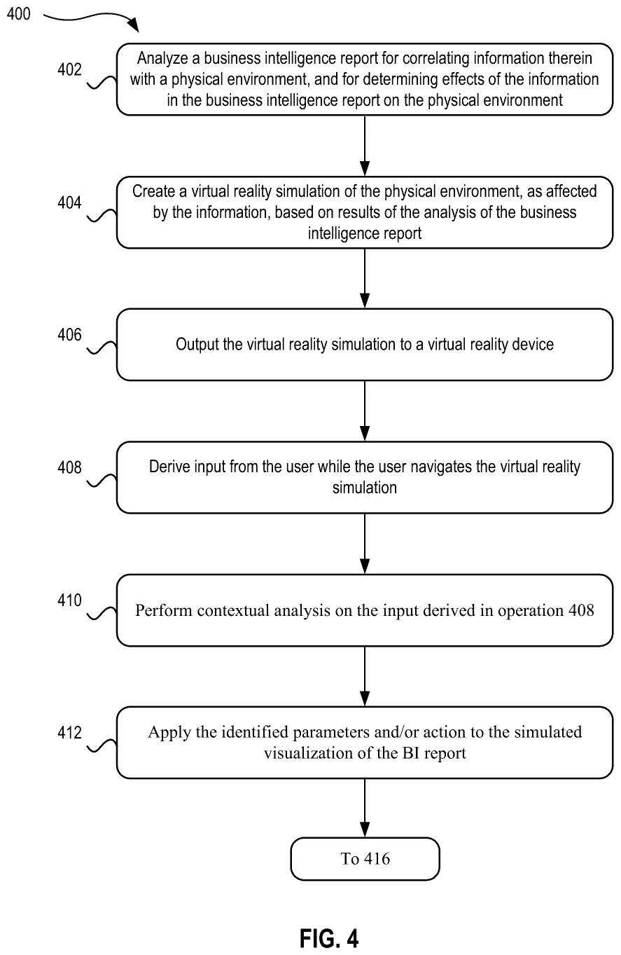

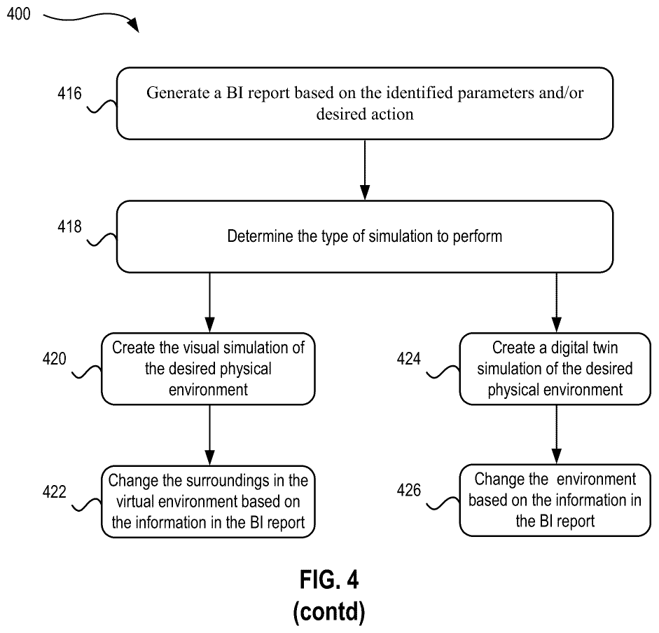

Now referring to FIG. 4, a flowchart of an illustrative method 400, for generating a virtual reality simulation of a physical environment as affected by BI report information, is shown according to one embodiment. The method 400 may be performed in accordance with the present invention in any of the environments depicted in FIGS. 1-3, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a BI system, a VR system, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, in which a BI report is analyzed for correlating information therein with a physical environment, and for determining effects of the information in the BI report on the physical environment.

In operation 404, a virtual reality simulation of the physical environment, as it is affected by the information, is created based on results of the analysis of the BI report.

In operation 406, the virtual reality simulation is output to a virtual reality device.

In operation 408, input is derived from the user while the user navigates the virtual reality simulation. Such input may be derived from gesture, body language, brain computer interface (BCI) signals, voice commands, virtual touch, etc.

In operation 410, contextual analysis is performed on the input derived in operation 408. Preferably, artificial intelligence is used to perform the contextual analysis, e.g., to identify selection of parameters by the user and/or a desired action from the user. Based on the results of the contextual analysis, the BI report parameters may be changed, e.g., one or more parameters are added, one or more parameters are removed, the value of one or more parameters is changed, etc. Similarly, based on the results of the contextual analysis, the user's desired action is identified, such as drill up, drill down, cross drilling, etc.

In operation 412, the identified parameters and/or action are applied to the simulated visualization of the BI report.

In operation 416, a BI report is generated based on the identified parameters and/or desired action. This may be performed in the background.

In operation 418, the type of simulation to perform is determined, e.g., based on the type of BI report, based on the parameters, based on the type of simulation currently being shown to the user, etc. Again, illustrative types of simulations include visual simulations, digital twin simulations, and a combination thereof.

If a visual simulation is selected in operation 418, the process proceeds to operation 420. If a digital twin simulation is selected in operation 418, the process proceeds to operation 424.

In operation 420, the virtual reality visual simulation is created, preferably when no further computation of the BI report is needed. Creation of the visual simulation may include use of any known VR simulation technique, such as by using a Generated Adversarial Network (GAN).

In operation 422, the surroundings in the virtual environment are changed, e.g., by a VR simulator module, based on the information in the BI report.

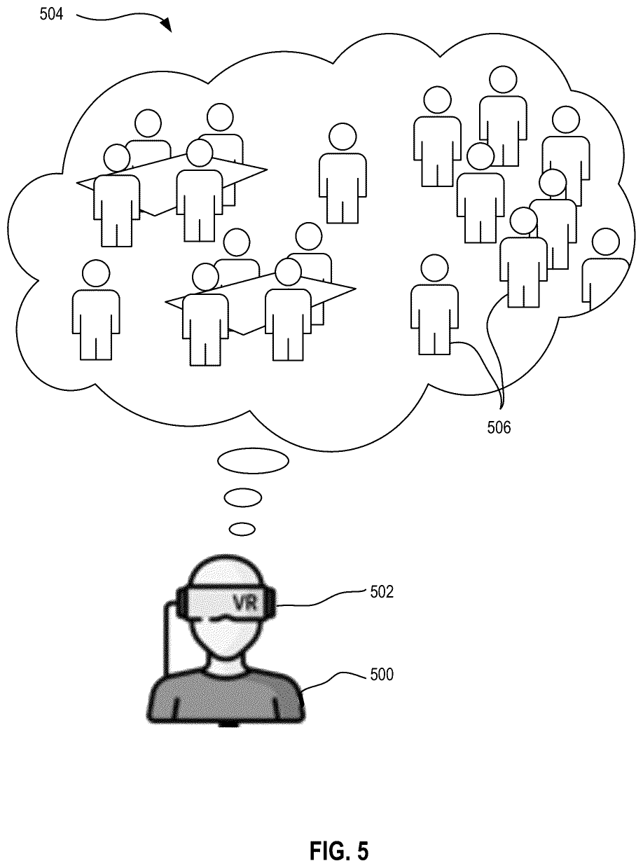

In one exemplary use case, a new product is about to be launched. Predictive data in the BI report is used to estimate the number of people that will come to a retail store on the day of launch, e.g., from a chart of predicted customer attendance numbers. Predictive information about the weather is also considered. A virtual reality simulation of the inside and outside of the retail store is created, with as much or as little detail as desired, and a number of avatars approximating the estimated number of people are placed in the retail store, along with intermittent rain at times corresponding to the weather information. FIG. 5 depicts an example of a user 500 wearing a VR device 502 to view a virtual reality simulation 504 of the inside of the retail store. Preferably, the avatars 506 representing real people are animated, and move around the store over time, as predicted according to the BI report information. Moreover, the system preferably detects when the user wishes to move to a different vantage point, e.g., via any of the input methods described herein.

The user is thus presented with a visualization representing how busy the retail store will be, as well as how the weather might affect the customers waiting outside. Moreover, as crowd levels may change over time, the virtual reality simulation may be made to progress across a given timeline, or go to a given point in time (in the future), ideally based on input derived from monitoring the user's interaction with the virtual reality simulation (see, e.g., operations 408-410). From the predictive simulation, the user can see what the flow of customers might look like upon occurrence of the actual product release. Note that numbers correlating to the BI report information may also be shown. At some point, the user changes the weather information to rainy all day. The simulated environment is altered to show the effect of the rain on the customers. At another point, the user drills down to predictive BI information corresponding to customers who only want to purchase the new product. The simulated environment may be altered to show only those customers present to purchase the new product.

Referring now to operation 424, a digital twin simulation of the desired physical environment is generated.

Changes to the simulated environment are also applied based on the BI report. See operation 426. Such changes may be made using visual simulations.

In one example of use, a digital twin simulation is to be generated to show what types of changes occurred on a production line. A digital twin of the production line is created, and then products moving along the production line are generated based on the BI report. For example, an existing report of machine health and productivity issues in terms of capacity of a conveyor system may be used to create a visual simulation of a reduction in product throughput for a particular period of time.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing a business intelligence report for correlating information therein with a physical environment, and for determining effects of the information in the business intelligence report on the physical environment;
creating an animated virtual reality simulation of the physical environment, as affected by the information, based on results of the analysis of the business intelligence report; and
outputting the animated virtual reality simulation to a virtual reality device.

2. The computer-implemented method of claim 1, wherein the animated virtual reality simulation includes a simulation of the physical environment at a time corresponding to when at least some of the information of the business intelligence report was collected.

3. The computer-implemented method of claim 1, wherein the animated virtual reality simulation includes a predictive simulation of the physical environment at a time in the future relative to when the information of the business intelligence report was collected.

4. The computer-implemented method of claim 3, wherein predictive information in the business intelligence report is identified and analyzed for generating the predictive simulation.

5. The computer-implemented method of claim 1, wherein the animated virtual reality simulation includes a digital twin of the physical environment upon which the information is based.

6. The computer-implemented method of claim 1, wherein the animated virtual reality simulation includes a combination of visual and digital twin simulations of the physical environment upon which the information is based.

7. The computer-implemented method of claim 1, comprising receiving input changing a time factor for the animated virtual reality simulation; and updating the animated virtual reality simulation to correspond to the changed time factor.

8. The computer-implemented method of claim 1, comprising receiving input indicating a selection of a different business intelligence report; analyzing the different business intelligence report for correlating information therein with the same physical environment, and for determining effects of the information in the business intelligence report on the physical environment; creating a second animated virtual reality simulation of the physical environment as affected by the information of the different business report; and outputting the second animated virtual reality simulation.

9. The computer-implemented method of claim 1, comprising receiving a set of parameters for defining the information in the business intelligence report.

10. The computer-implemented method of claim 1, comprising receiving a set of parameters for defining a context of the analysis, and performing the analysis based on the set of parameters.

11. The computer-implemented method of claim 10, wherein the set of parameters is derived from a selection of particular information from the business intelligence report to analyze.

12. The computer-implemented method of claim 10, wherein the set of parameters is based, at least in part, on output from one or more sensors detecting one or more human interactions selected from the group consisting of: a gesture, body language, brain computer interface (BCI) signals, a voice command, and a virtual touch.

13. The computer-implemented method of claim 12, wherein the set of parameters is received during the outputting of the animated virtual reality simulation, wherein the animated virtual reality simulation is updated based on the set of parameters.

14. The computer-implemented method of claim 1, comprising receiving specification of the physical environment, wherein the analysis includes selection of information in the business intelligence report relevant to the specified physical environment.

15. The computer-implemented method of claim 1, wherein the animated virtual reality simulation is also output to a second animated virtual reality device for allowing collaboration of multiple users in the animated virtual reality simulation.

16. The computer-implemented method of claim 15, wherein portions of the animated virtual reality simulation output to the second animated virtual reality device are removed based on a permission level of the user associated with the second virtual reality device.

17. The computer-implemented method of claim 1, comprising:
performing a second analysis of the business intelligence report based on a permission level of a second user;
creating a second animated virtual reality simulation of the physical environment as affected by the information based on results of the second analysis; and
outputting the animated virtual reality simulation to a second virtual reality device for allowing collaboration of multiple users in the animated virtual reality simulations.

18. The computer-implemented method of claim 17, wherein avatars of the users are generated and presented in both of the animated virtual reality simulations.

19. A computer program product, the computer program product comprising a computer readable storage medium having program instructions embodied therewith, the program instructions executable by a computer to cause the computer to:
analyze, by the computer, a business intelligence report for correlating information therein with a physical environment, and for determining effects of the information in the business intelligence report on the physical environment;
create, by the computer, an animated virtual reality simulation of the physical environment, as affected by the information, based on results of the analysis of the business intelligence report; and
output, by the computer, the animated virtual reality simulation to a virtual reality device.

20. A system, comprising:
a processor; and
logic integrated with the processor, executable by the processor, or integrated with and executable by the processor, the logic being configured to:
analyze a business intelligence report for correlating information therein with a physical environment, and for determining effects of the information in the business intelligence report on the physical environment;
create an animated virtual reality simulation of the physical environment, as affected by the information, based on results of the analysis of the business intelligence report; and
output the animated virtual reality simulation to a virtual reality device.
